(19) United States
(12) Patent Application Publication
(10) Pub. No.: US 2026/0332940 A1
(43) Pub. Date: Oct. 22, 2026

(54) ACOUSTIC DEVICE

(71) Applicant: Murata Manufacturing Co., Ltd., Nagaokakyo-shi (JP)

(72) Inventors: Shungo KANAI, Nagaokakyo-shi (JP); Tadashi Okuzawa, Nagaokakyo-shi (JP)

(21) Appl. No.: 19/705,995

(22) Filed: Jun. 12, 2026

Related U.S. Application Data
(63) Continuation of application No. PCT/JP2024/044157, filed on Dec. 13, 2024.

(30) Foreign Application Priority Data
Jan. 16, 2024 (JP) 2024-004841

(51) Int. Cl. H04R 1/28

(52) U.S. Cl. CPC H04R 1/2807; H04R 1/2892; H04R 2201/021

(57) ABSTRACT

An acoustic device is provided that includes a matching unit disposed on a wall surface of a housing and configured to match acoustic impedance for propagating sound from a sound source through the housing. The matching unit includes a support frame having an end surface that is in contact with the wall surface of the housing, a vibrating membrane supported by the support frame, and a mounting member that attaches the support frame to the wall surface of the housing.

### CROSS REFERENCE TO RELATED APPLICATIONS

The present application is a continuation of International Application No. PCT/JP2024/044157, filed Dec. 13, 2024, which claims priority to Japanese Patent Application No. 2024-004841, filed Jan. 16, 2024, the entire contents of each of which are incorporated herein by reference.

### TECHNICAL FIELD

The present disclosure relates to an acoustic device.

### BACKGROUND

An acoustic device is a device that propagates sound from a sound source. For example, an acoustic device includes a sound source and a housing that accommodates the sound source. The housing obstructs the propagation of sound. Accordingly, acoustic devices need to have an arrangement for facilitating the propagation of sound through the housing.

As an example, International Publication No. 2021/192417 discloses an ultrasonic transducer equipped with a first acoustic transducer, a second acoustic transducer, and a housing with a bottomed tubular shape. The second acoustic transducer includes a second membrane section, an annular section supporting the second membrane section, and an acoustic matching plate opposing the second membrane section with a space provided therebetween and defining a sealed space with the housing.

According to International Publication No. 2021/192417, successful matching of acoustic impedance requires highly accurate provision of the gap between the acoustic matching plate and the second membrane section. However, the presence of an adhesive layer between the acoustic matching plate and the second membrane section deteriorates the accuracy of the gap size between the acoustic matching plate and the second membrane section due to the thickness variation of the adhesive layer. This configuration may result in unsuccessful matching of acoustic impedance or may decrease or vary the pressure of the sound propagated to the outside.

### SUMMARY OF THE INVENTION

In view of the foregoing, an exemplary aspect of the present disclosure provides an acoustic device that maximizes the propagation efficiency of sound and also reduces the variation therein.

According to an exemplary aspect, an acoustic device is provided that includes a matching unit disposed on a wall surface of a housing and that is configured to match acoustic impedance for propagating sound from a sound source through the housing. In the acoustic device, the matching unit includes a support frame having an end surface in contact with the wall surface of the housing, a vibrating membrane supported by the support frame, and a mounting member that attaches the support frame to the wall surface of the housing.

According to another exemplary aspect, an acoustic device is provided that includes a sound source, and a matching unit disposed on a wall surface of a housing and that is configured to match acoustic impedance for propagating sound from the sound source through the housing. In the acoustic device, the matching unit includes a support frame having an end surface that is in contact with the wall surface of the housing, a vibrating membrane supported by the support frame, and a mounting member that attaches the support frame to the wall surface of the housing.

According to yet another exemplary aspect, an acoustic device is provided that includes a housing, a sound source, and a matching unit disposed on a wall surface of the housing and configured to match acoustic impedance for propagating sound from the sound source through the housing. In the acoustic device, the matching unit includes a support frame having an end surface that is in contact with the wall surface of the housing, a vibrating membrane supported by the support frame, and a mounting member that attaches the support frame to the wall surface of the housing.

According to the exemplary aspects of the present disclosure, an acoustic device is provided that maximizes the propagation efficiency of sound and reduces the variation therein.

### BRIEF DESCRIPTION OF DRAWINGS

FIG. 1 is an exploded perspective view illustrating an acoustic device according to a first exemplary embodiment.

FIG. 2 is a cross-sectional view illustrating the acoustic device of the first exemplary embodiment.

FIG. 3 is a plan view illustrating a matching unit of the first exemplary embodiment.

FIG. 4 is a plan view illustrating a matching unit according to a second exemplary embodiment.

FIG. 5 is a plan view illustrating a matching unit according to a third exemplary embodiment.

FIG. 6 is a cross-sectional view illustrating a matching unit according to a fourth exemplary embodiment.

FIG. 7 is a cross-sectional view illustrating a matching unit according to a fifth exemplary embodiment.

FIG. 8 is a cross-sectional view illustrating a matching unit according to a sixth exemplary embodiment.

FIG. 9 is a cross-sectional view illustrating a matching unit according to a seventh exemplary embodiment.

FIG. 10 is a cross-sectional view illustrating a matching unit according to an eighth exemplary embodiment.

FIG. 11 is a cross-sectional view illustrating a matching unit according to a ninth exemplary embodiment.

FIG. 12 is a cross-sectional view illustrating an acoustic device according to a tenth exemplary embodiment.

FIG. 13 is a cross-sectional view illustrating an acoustic device according to an eleventh exemplary embodiment.

FIG. 14 is a cross-sectional view illustrating an acoustic device according to a twelfth exemplary embodiment.

FIG. 15 is a cross-sectional view illustrating an acoustic device according to a thirteenth exemplary embodiment.

FIG. 16 is a cross-sectional view illustrating an acoustic device according to a fourteenth exemplary embodiment.

FIG. 17 is a plan view illustrating a matching unit according to a fifteenth exemplary embodiment.

FIG. 18 is a cross-sectional view illustrating an acoustic device of the fifteenth exemplary embodiment.

FIG. 19 is a cross-sectional view illustrating an acoustic device according to a sixteenth exemplary embodiment.

### DETAILED DESCRIPTION OF EMBODIMENTS

Exemplary embodiments of the present disclosure are described below. It is noted that identical or similar reference signs denote identical or similar elements in the description of the drawings. Moreover, the drawings are illustrative, and the dimensions and shapes of components are schematic. The exemplary embodiments are not intended to limit the technical scope of the present disclosure.

### First Exemplary Embodiment

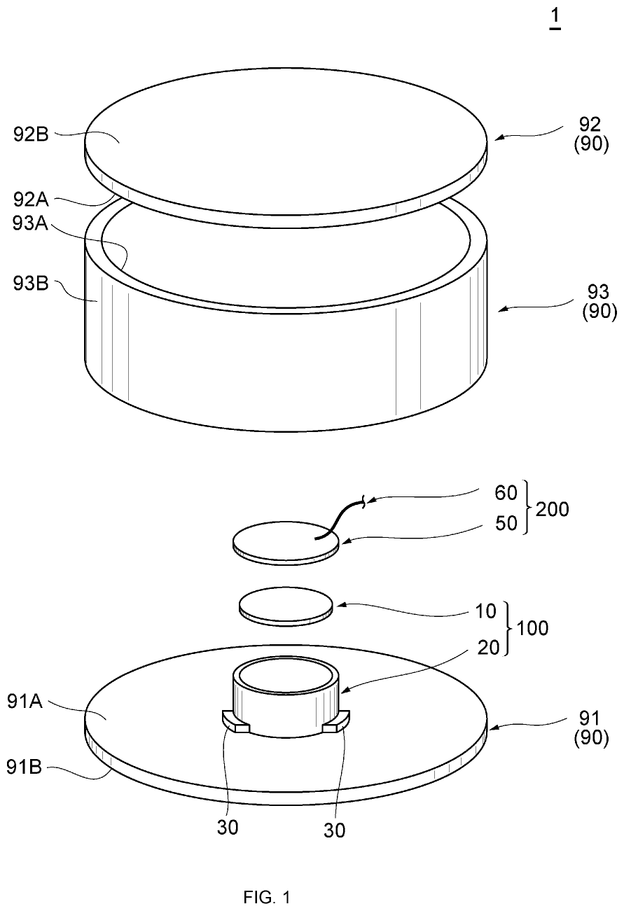

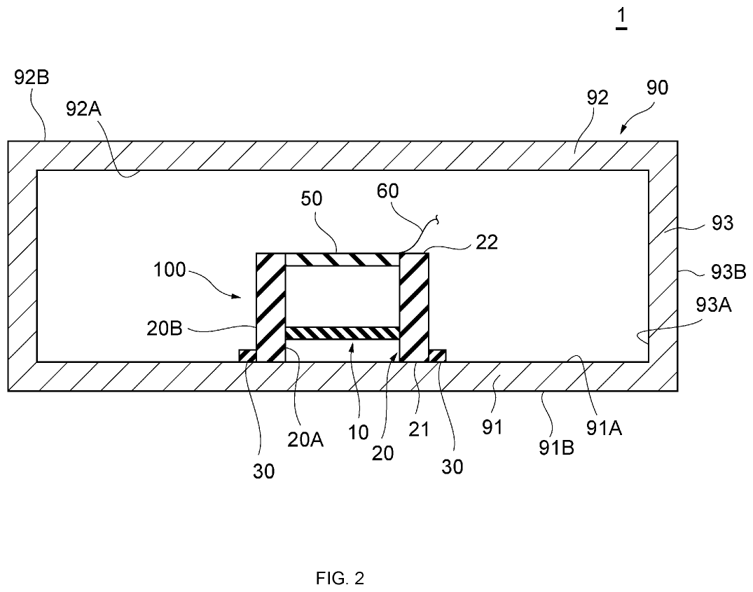

The structure of an acoustic device according to a first exemplary embodiment will be described with reference to FIGS. 1 and 2. FIG. 1 is an exploded perspective view illustrating the acoustic device according to the first embodiment. FIG. 2 is a cross-sectional view illustrating the acoustic device of the first embodiment.

As shown, an acoustic device 1 includes a housing 90, a matching unit 100, and a sound-producing component 200.

The housing 90 is a housing that accommodates the matching unit 100 and the sound-producing component 200 in its internal space, and more specifically, the housing 90 is a housing of a sound-emitting product, for example, a home appliance or a mobile device. The housing 90 seals the internal space. For example, the housing 90 is shaped like a cylinder in the exemplary aspect. The materials of main walls 91 and 92 and a side wall 93 are not specifically limited and can be appropriately selected from metals, ceramics, semiconductors, resins, and the like. In an exemplary aspect, the materials of the main walls 91 and 92 and the side wall 93 are the same, but the materials may be different from each other in other exemplary aspects.

The housing 90 has the main walls 91 and 92 and the side wall 93. The main wall 91 and the main wall 92 oppose each other. The main walls 91 and 92 (e.g., top and bottom walls) are shaped like discs. One end of the side wall 93 is connected to the edge portion of the main wall 91, and the other end of the side wall 93 is connected to the edge portion of the main wall 92. In other words, the side wall 93 connects the edge portions of the main walls 91 and 92. The side wall 93 is shaped like a hollow and continuous cylinder as shown in the exemplary aspect.

The main wall 91 has an inner wall-surface 91A that faces the main wall 92 and the side wall 93, and the main wall 91 has an outer wall-surface 91B on the side opposite to the inner wall-surface 91A. The main wall 92 has an inner wall-surface 92A that faces the main wall 91 and the side wall 93, and the main wall 92 has an outer wall-surface 92B on the side opposite to the inner wall-surface 92A. The side wall 93 has an inner wall-surface 93A that faces the main walls 91 and 92, and the side wall 93 has an outer wall-surface 93B on the side opposite to the inner wall-surface 93A. The inner wall-surfaces 91A, 92A, and 93A are the inner surfaces of the housing 90 that define the internal space in which the matching unit 100 and the sound-producing component 200 are accommodated. The outer wall-surfaces 91B, 92B, and 93B are the outer surfaces of the housing 90 that are exposed to the external space. For purposes of this disclosure, the inner wall-surfaces 91A, 92A, and 93A and the outer wall-surfaces 91B, 92B, and 93B are examples of a “wall surface of the housing”.

It is noted that the housing is not limited to the one in which the internal space is sealed. The housing does not need to be sealed, in other words, the internal space of the housing may be in communication with the external space. In this case, cylindrical or slit-like holes may be made in a main wall or the side wall of the housing. Moreover, the shape of the housing is not limited to the cylindrical shape insofar as the housing can accommodate the matching unit and the sound-producing component. For example, the housing may be shaped like a polygonal column, an elliptic cylinder, a prismoid, a truncated cone, a truncated elliptic cone, a sphere, an elliptic sphere, or any combination of these.

The matching unit 100 is configured to propagate, through the housing 90, the sound that comes from (e.g., generated by) a sound source 50 included in the sound-producing component 200. The matching unit 100 is disposed on the inner wall-surface 91A of the main wall 91. The matching unit 100 is configured to match the acoustic impedance of the main wall 91 of the housing 90 with the acoustic impedance of a gas filling the internal space of the housing 90 at the acoustic frequency of the sound emitted by the sound source 50. For example, the gas in the internal space of the housing 90 is air, and the acoustic impedance of the air differs significantly from the acoustic impedance of the main wall 91 of the housing 90. Although sound is reflected at the boundary between media with significantly different acoustic impedances, the sound reflection at the inner wall-surface 91A of the main wall 91 is suppressed due to the matching unit 100 matching the acoustic impedances. In other words, the matching unit 100 causes the sound emitted from the sound source 50 in the internal space of the housing 90 to propagate efficiently to the external space of the housing 90.

According to an exemplary aspect, the internal space of the housing 90 is filled, for example, with air, but the filling material is not limited to the air. The internal space of the housing 90 may be filled with any fluid that allows the sound emitted by the sound-producing component 200 to propagate according to various exemplary aspects. The fluid filling the internal space of the housing 90 may be an inert gas such as a rare gas or nitrogen gas, a mixed gas containing air, or a liquid such as water.

As further shown, the matching unit 100 includes a support frame 20, a vibrating membrane 10, and a mounting member 30.

The support frame 20 is disposed on the inner wall-surface 91A of the main wall 91 of the housing 90. The support frame 20 supports the vibrating membrane 10 and can be shaped like a tube, for example, a hollow cylinder. The material of the support frame 20 is not specifically limited but may be appropriately selected from metals, ceramics, semiconductors, resins, and the like.

The support frame 20 has end surfaces 21 and 22, an inner surface 20A, and an outer surface 20B.

The end surface 21 is a frame-shaped surface that connects the inner surface 20A and the outer surface 20B on the side facing the main wall 91. The end surface 22 is a frame-shaped surface that connects the inner surface 20A and the outer surface 20B on the side facing the main wall 92. The end surface 21 is in contact with the inner wall-surface 91A of the main wall 91 of the housing 90. In other words, the end of the support frame 20 at the end surface 21 is a closed end closed by the inner wall-surface 91A. When the end surface 21 and the inner wall-surface 91A are in contact with each other, it is sufficient that at least part of the end surface 21 is in direct contact with the inner wall-surface 91A without any gap or adhesive layer being interposed therebetween. The sound source 50 of the sound-producing component 200 is disposed at an end portion of the support frame 20 near the end surface 22. For purposes of this disclosure, the end portion of the support frame 20 near the end surface 21 is an example of “an end of the support frame,” and the end portion of the support frame 20 near the end surface 22 is an example of “another end of the support frame.”

The inner surface 20A is a side surface of the support frame 20 opposite to the outer surface 20B. The outer surface 20B is the side surface that faces the side wall 93 of the housing 90. In addition, the vibrating membrane 10 is connected to the inner surface 20A at a position away from both end surfaces 21 and 22. The mounting member 30 is disposed on the outer surface 20B near the end surface 21.

The vibrating membrane 10 is supported by the support frame 20. More specifically, the entire circumference of the vibrating membrane 10 is connected to the inner surface 20A of the support frame 20. The vibrating membrane 10 is disposed at a predetermined distance from the inner wall-surface 91A of the main wall 91 of the housing 90. The vibrating membrane 10 divides the space surrounded by the inner surface 20A of the support frame 20 into a space near the end surface 21 and a space near the end surface 22. The space defined by the support frame 20, the vibrating membrane 10, and the main wall 91 of the housing 90 is sealed. As viewed in plan in the direction in which the main wall 91 and the main wall 92 overlap (hereinafter referred to simply as “viewed in plan”), the central portion of the vibrating membrane 10 overlaps, for example, the central portions of the main walls 91 and 92 of the housing 90, but the positional relationship of the central portions is not limited to this configuration. As viewed in plan, the central portion of the vibrating membrane 10 may be deviated from the central portions of the main walls 91 and 92 in various exemplary aspects.

Moreover, the vibrating membrane 10 has a thickness in the direction in which the main wall 91 and the main wall 92 oppose each other and has principal surfaces stretching along the inner wall-surfaces 91A and 92A of the main walls 91 and 92. The vibrating membrane 10 is held by the support frame 20 so as to allow the vibrating membrane 10 to be displaced in the thickness direction, which is defined as the thickness direction of the vibrating membrane 10. The vibrating membrane 10 is vibrated by the sound propagated from the sound-producing component 200, thereby causing the matching unit 100 to match the acoustic impedance of the internal space of the housing 90 with the acoustic impedance of the main wall 91 of the housing 90. It is noted that the material of the vibrating membrane 10 is not specifically limited but can be appropriately selected from metals, ceramics, semiconductors, resins, and the like. The material, mass, and position of the vibrating membrane 10 are appropriately designed in accordance with the acoustic frequency of the sound-producing component 200 for which the acoustic impedance is matched, with the acoustic impedance of the gas in the internal space of the housing 90, and with the acoustic impedance of the main wall 91 of the housing 90.

The mounting member 30 is a component that attaches the support frame 20 to the inner wall-surface 91A of the main wall 91 of the housing 90. The matching unit 100 is fixed to the main wall 91 by attaching the mounting member 30 to the inner wall-surface 91A. it is noted that the method of attaching the mounting member 30 to the inner wall-surface 91A is not specifically limited. For example, the mounting member 30 may be engaged with or fitted on a protrusion disposed on the inner wall-surface 91A or may be screw-engaged in a groove formed at the inner wall-surface 91A. The mounting member 30 may be joined to the main wall 91 using a joining member such as a screw or an adhesive. When the mounting member 30 is engaged with, fitted to, or screw-engaged with the inner wall-surface 91A, the mounting member 30 may be in contact with the inner wall-surface 91A. When the mounting member 30 is joined to the inner wall-surface 91A using a joining member such as the screw or adhesive, the mounting member 30 may be in contact with the inner wall-surface 91A or may be separated from the inner wall-surface 91A.

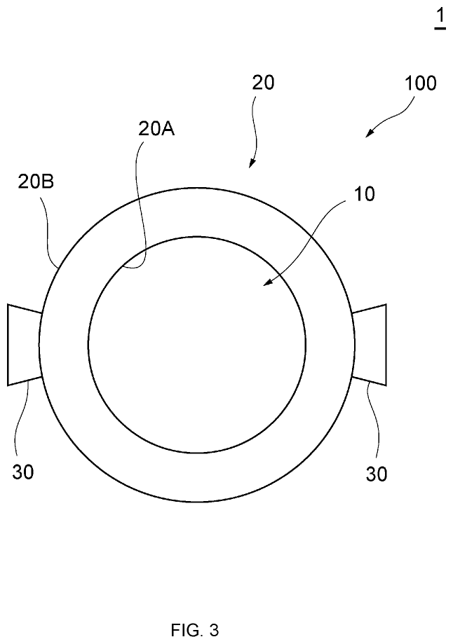

The mounting member 30 is disposed on the outer surface 20B of the support frame 20. In particular, the mounting member 30 is disposed at the end portion of the support frame 20 near the end surface 21. For example, the mounting member 30 is disposed closer to the end surface 21 of the support frame 20 than the vibrating membrane 10 to the end surface 21. As illustrated in FIG. 3, the mounting member 30 is provided at two positions on the outer surface 20B. As viewed in plan, the positions at which the mounting member 30 is disposed oppose each other with the vibrating membrane 10 being interposed therebetween.

It is noted that the position of the mounting member is not limited to the above configuration. For example, the mounting member may be provided on the outer surface of the support frame at an end portion of the support frame being opposite to the end connected to the housing. The mounting member may also be provided on the outer surface of the support frame so as to extend from the end portion of the support frame being connected to the housing to the end portion opposite thereto. The mounting member may also be provided on the end surface of the support frame positioned opposite to the end surface being in contact with the housing. The mounting member may also be provided at one position or at three or more positions on the outer surface of the support frame.

The sound-producing component 200 is configured to emit sound. The sound-producing component 200 is connected to the end portion of the matching unit 100 near the end surface 22. The sound-producing component 200 includes the sound source 50 and wiring 60.

The sound source 50 is supported by the support frame 20. More specifically, the entire circumference of the sound source 50 is connected to the inner surface 20A of the support frame 20 at a position near the end surface 22. The sound source 50 is positioned so as to oppose the vibrating membrane 10 with a space provided therebetween in the thickness direction. For example, the sound source 50 is a piezoelectric vibrating element made of a piezoelectric material, such as quartz, PZT, AlN, lithium niobate, or lithium tantalate.

The sound source 50 has a thickness in the direction in which the main wall 91 and the main wall 92 oppose each other and has principal surfaces stretching along the inner wall-surfaces 91A and 92A of the main walls 91 and 92. The sound source 50 is held by the support frame 20 so as to be able to vibrate in the displacement direction of the vibrating membrane 10. As viewed in plan, the central portion of the sound source 50 overlaps the central portions of the main walls 91 and 92 of the housing 90.

It is noted that the configuration of the sound source is not limited to the above configuration. For example, the sound source may be connected to the end surface 22 of the support frame 20 instead of the inner surface 20A. When the sound source is a vibrating element, the driving force that vibrates the sound source may be an electrostatic force or an electromagnetic force. The sound source may be a buzzer or speaker having a case according to exemplary aspects.

The wiring 60 is configured to apply an electric signal to the sound source 50. The wiring 60 connects the sound source 50 to an external circuit, of which the illustration is omitted. The wiring 60 is extended to the outside of the acoustic device 1 through the main wall 91, the main wall 92, or the side wall 93, or is connected to a power source inside the acoustic device 1.

According to the present embodiment, as described above, the acoustic device 1 includes the matching unit 100 disposed on the inner wall-surface 91A of the housing 90. The matching unit 100 matches the acoustic impedance in order to propagate the sound from the sound source 50 through the housing 90. The matching unit 100 includes the support frame 20 having the end surface 21 being in contact with the inner wall-surface 91A of the housing 90, the vibrating membrane 10 supported by the support frame 20, and the mounting member 30 for attaching the support frame 20 to the inner wall-surface 91A of the housing 90.

According to this configuration, the support frame 20 is in contact with the main wall 91 of the housing 90. Insofar as the vibrating membrane 10 and the support frame 20 are formed such that the support frame 20 supports the vibrating membrane 10 with a designed positional accuracy, the thickness of a joining member such as an adhesive layer does not affect the acoustic device when attaching the matching unit 100 onto the housing 90. This can reduce the variation of the gap between the vibrating membrane 10 and the main wall 91 of the housing 90. Accordingly, this configuration improves the accuracy of the impedance matching between the acoustic impedance of the internal space of the housing 90 and the acoustic impedance of the main wall 91 of the housing 90. In other words, this configuration maximizes the propagation efficiency of the sound propagated from the sound source 50 through the housing 90 and reduces the variation of the propagation efficiency.

As a variation of the present embodiment, the mounting member 30 may be provided at two positions or more at the support frame 20.

According to this configuration, when the mounting members 30 are connected, the support frame 20 is prevented from inclining relative to the inner wall-surface 91A of the housing 90. Accordingly, this configuration suppresses positional variations of the matching unit 100 relative to the housing 90 and reduces the variation of the gap between the vibrating membrane 10 and the main wall 91 of the housing 90.

It is noted that although the matching unit and the sound source are provided in the internal space of the housing in the present embodiment, the matching unit and the sound source may be provided in the external space of the housing in an alternative aspect. In this case, for example, the housing may accommodate a microphone in the internal space of the housing, and the microphone may collect the sound emitted from the sound source through the walls of the housing. In the present embodiment, the sound source is connected to the matching unit, but the sound source may be provided at a position away from the matching unit. The sound source and the matching unit may be such that one is disposed in the internal space of the housing and the other is disposed in the external space of the housing. Two matching units may be provided such that one is disposed on the inner wall-surface of the housing and the other is disposed on the outer wall-surface with the main wall of the housing being interposed between the one matching unit and the other.

Additional exemplary embodiments are described below. It is noted that elements identical or similar to those described in the first embodiment are denoted by identical or similar reference signs, and their descriptions are omitted as appropriate. In addition, similar advantageous effects resulting from similar configurations will not be repeated.

### Second Exemplary Embodiment

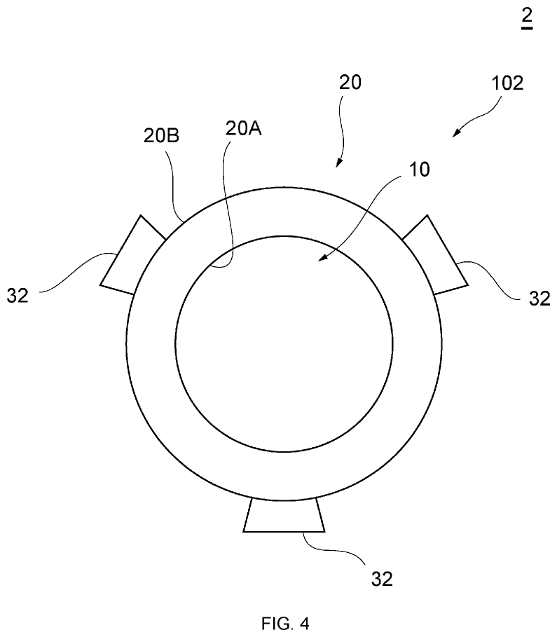

Next, the structure of an acoustic device 2 according to the second exemplary embodiment will be described with reference to FIG. 4. FIG. 4 is a plan view illustrating a matching unit of the second embodiment.

In this aspect, a matching unit 102 of the acoustic device 2 includes mounting members 32 disposed at three locations. The mounting members 32 are disposed on the outer surface 20B of the support frame 20 circumferentially at three equidistant positions. This configuration further stabilizes the position of the matching unit 102.

### Third Exemplary Embodiment

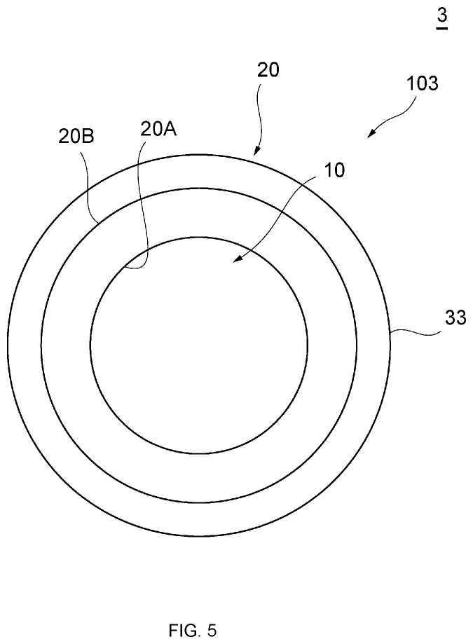

Next, the structure of an acoustic device 3 according to the third exemplary embodiment will be described with reference to FIG. 5. FIG. 5 is a plan view illustrating a matching unit of the third embodiment.

A matching unit 103 of the acoustic device 3 includes mounting members 33 disposed around the entire circumference. The mounting members 33 is a frame-like unit disposed continuously around the entire circumference of the outer surface 20B of the support frame 20. This configuration further stabilizes the position of the matching unit 103.

### Fourth Exemplary Embodiment

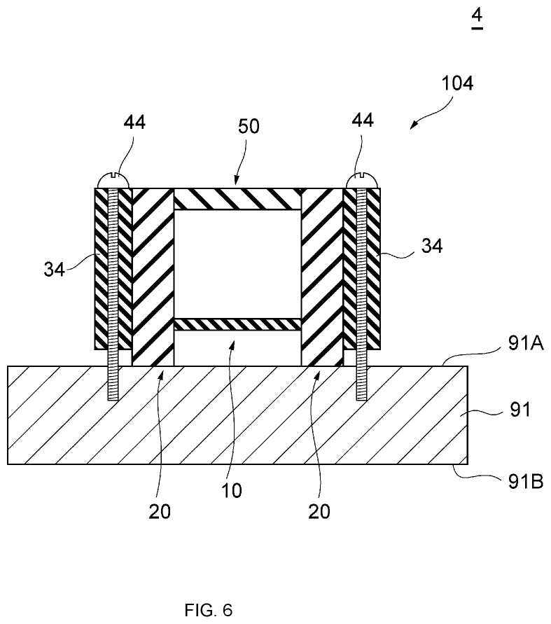

Next, the structure of an acoustic device 4 according to the fourth exemplary embodiment will be described with reference to FIG. 6. FIG. 6 is a cross-sectional view of a matching unit of the fourth embodiment.

In this aspect, a matching unit 104 of the acoustic device 4 further includes a connection member 44 that connects a mounting member 34 to the main wall 91 of the housing. A mounting member 34 is disposed so as to have a space from the main wall 91. In other words, the mounting member 34 is spaced from the main wall 91. The connection member 44 is a screw piercing through the mounting member 34. The tip end of the connection member 44 is threaded in the main wall 91. The head of the connection member 44 is positioned at a side of the mounting member 34 opposite to the side facing the main wall 91.

### Fifth Exemplary Embodiment

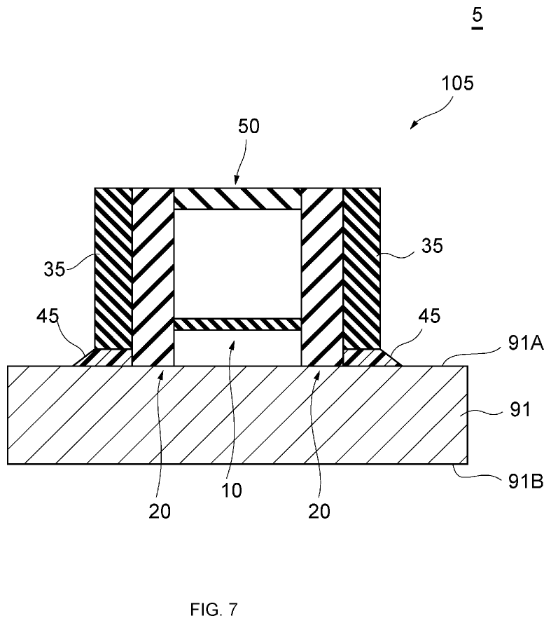

Next, the structure of an acoustic device 5 according to the fifth exemplary embodiment will be described with reference to FIG. 7. FIG. 7 is a cross-sectional view illustrating a matching unit of the fifth embodiment.

In this aspect, a matching unit 105 of the acoustic device 5 further includes a connection member 45 that connects a mounting member 35 to the main wall 91 of the housing. The mounting member 35 is disposed so as to have a space from the main wall 91. The connection member 45 is an adhesive layer that adheres the mounting member 35 to the main wall 91. The connection member 45 is formed in the space between the mounting member 35 and the main wall 91.

### Sixth Exemplary Embodiment

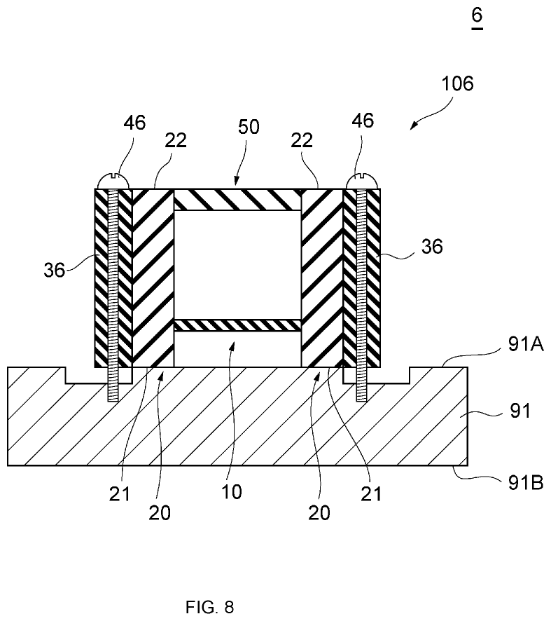

Next, the structure of an acoustic device 6 according to the sixth exemplary embodiment will be described with reference to FIG. 8. FIG. 8 is a cross-sectional view illustrating a matching unit of the sixth embodiment.

In a matching unit 106 of the acoustic device 6, a mounting member 36 is disposed on the support frame 20 so as to extend from the end of the support frame 20 near the end surface 21 to the other end near the end surface 22. A recess is formed at the inner wall-surface 91A of the main wall 91 of the housing in a region opposing the mounting member 36. In other words, a step is formed at the inner wall-surface 91A between a region opposing the support frame 20 and the region opposing the mounting member 36. A gap is thereby formed between the mounting member 36 and the main wall 91. A connection member 46, which can be a screw that pierces through the mounting member 36, connects the mounting member 36 to the main wall 91.

### Seventh Exemplary Embodiment

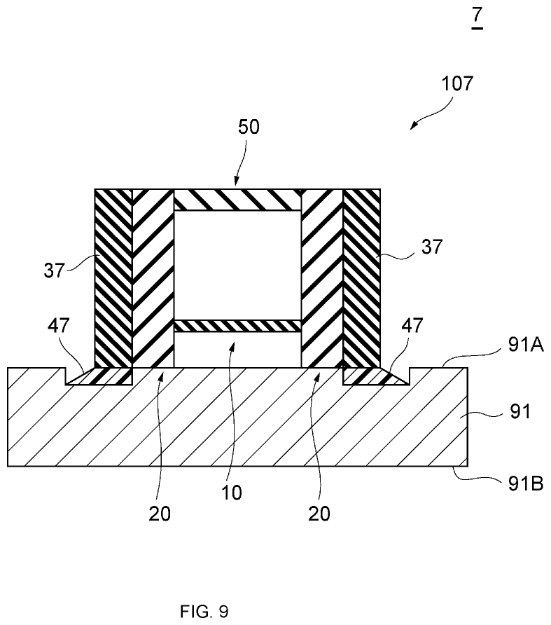

Next, the structure of an acoustic device 7 according to the seventh exemplary embodiment will be described with reference to FIG. 9. FIG. 9 is a cross-sectional view illustrating a matching unit of the seventh embodiment.

In the acoustic device 7, the main wall 91 of the housing is shaped similarly to the main wall 91 of the housing of the acoustic device 6. An adhesive layer 47 is formed in the recess of the main wall 91, and the adhesive layer 47 connects a mounting member 37 to the main wall 91.

### Eighth Exemplary Embodiment

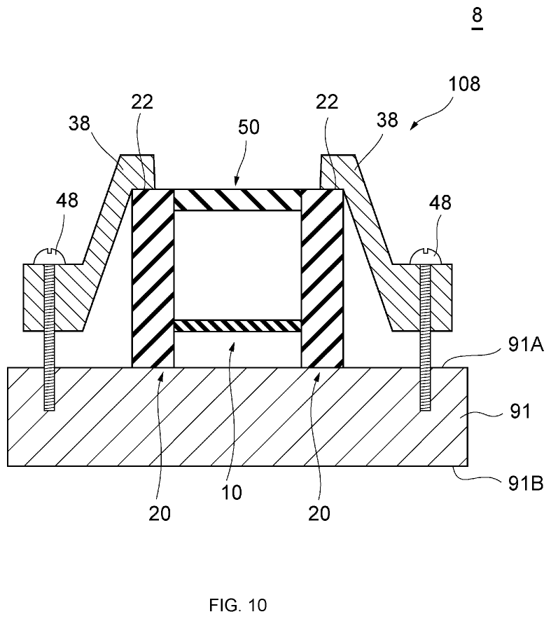

Next, the structure of an acoustic device 8 according to the eighth exemplary embodiment will be described with reference to FIG. 10. FIG. 10 is a cross-sectional view illustrating a matching unit of the eighth embodiment.

In a matching unit 108 of the acoustic device 8, a mounting member 38 is detachably mounted on the support frame 20. An end portion of the mounting member 38 is in contact with the end surface 22 of the support frame 20 and thereby urges the support frame 20 toward the main wall 91 of the housing. The other end portion of the mounting member 38 can be screw-connected to the main wall 91 using connection members 48 with a space provided therebetween.

### Ninth Exemplary Embodiment

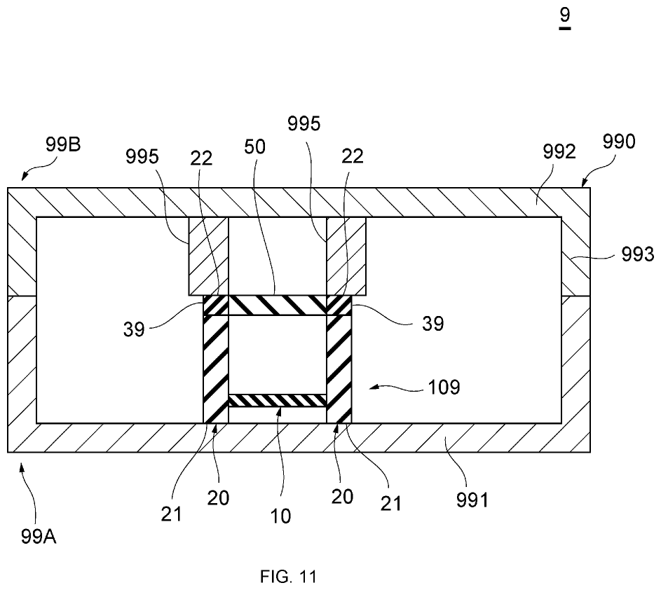

Next, the structure of an acoustic device 9 according to the ninth exemplary embodiment will be described with reference to FIG. 11. FIG. 11 is a cross-sectional view illustrating a matching unit of the ninth embodiment.

In a matching unit 109 of the acoustic device 9, a mounting member 39 is disposed at the end portion of the support frame 20 near the end surface 22. A housing 990 is structured to be separated at a mid-portion of a side wall 993. The housing 990 can be made of a first portion 99A that includes a main wall 991 and a second portion 99B that includes a main wall 992. For example, the first portion 99A is engaged with, fitted in, or screw-engaged with the second portion 99B to form the housing 990.

The support frame 20 is held tightly by the first portion 99A and the second portion 99B. The second portion 99B has a protrusion 995 that comes into contact with the mounting member 39. The end surface 21 of the support frame 20 is in contact with the first portion 99A, and the support frame 20 is urged toward the second portion 99B by the elastic force of the first portion 99A that is connected to the second portion 99B. The mounting member 39 is in contact with the protrusion 995 of the second portion 99B, and the support frame 20 is urged toward the first portion 99A by the elastic force of the second portion 99B that is connected to the first portion 99A.

With this configuration, the end surface 21 of the support frame 20 is made to be in contact with the main wall 991 without providing any connection member, which simplifies the manufacturing process.

### Tenth Exemplary Embodiment

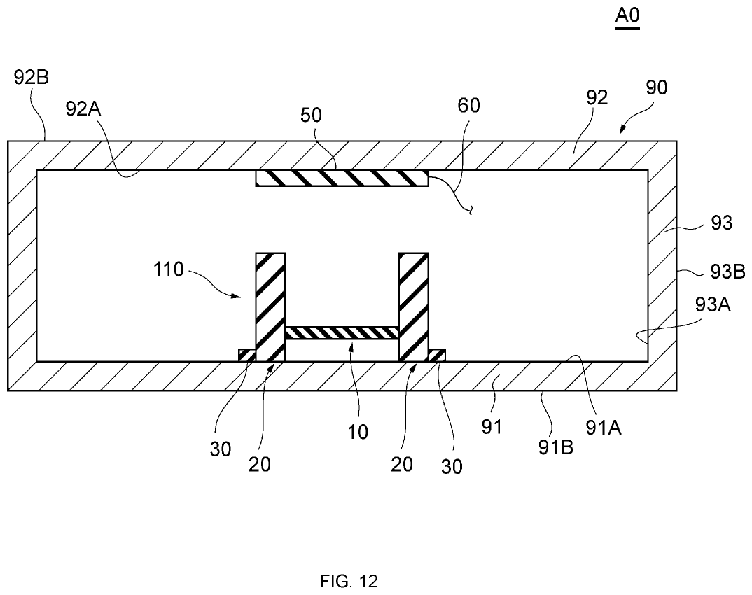

Next, the structure of an acoustic device A0 according to the tenth exemplary embodiment will be described with reference to FIG. 12. FIG. 12 is a cross-sectional view illustrating the acoustic device of the tenth embodiment.

In the acoustic device A0, a matching unit 110 is disposed away from the sound source 50. More specifically, the support frame 20 of the matching unit 110 is disposed away from the sound source 50. For example, the sound source 50 is disposed on the inner wall-surface 92A of the main wall 92 of the housing 90. For example, the central portion of the sound source 50 overlaps the central portion of the vibrating membrane 10 when the inner wall-surface 91A on which the matching unit 110 is disposed is viewed in plan.

It is noted that the position of the sound source 50 is not limited to the above. As viewed in plan, the central portion of the sound source 50 may be deviated from the central portion of the vibrating membrane 10. Moreover, the sound source 50 may be disposed on the inner wall-surface 93A of the side wall 93.

### Eleventh Exemplary Embodiment

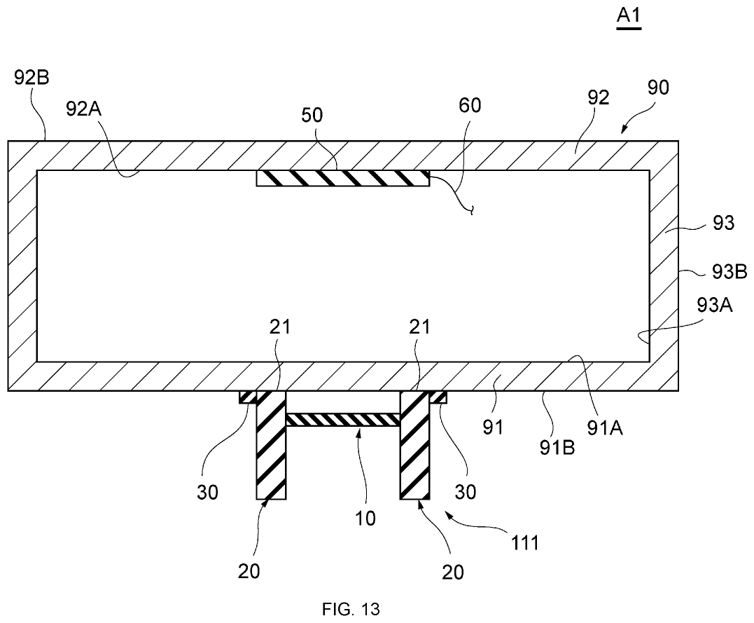

Next, the structure of an acoustic device A1 according to the eleventh exemplary embodiment will be described with reference to FIG. 13. FIG. 13 is a cross-sectional view illustrating the acoustic device of the eleventh embodiment.

In the acoustic device A1, a matching unit 111 is disposed in the external space of the housing 90. More specifically, the matching unit 111 is disposed on the outer wall-surface 91B of the main wall 91 of the housing 90. The support frame 20 is attached to the outer wall-surface 91B of the main wall 91 by the mounting member 30, and the end surface 21 of the support frame 20 is in contact with the outer wall-surface 91B. For example, the sound source 50 is disposed on the inner wall-surface 92A of the main wall 92 of the housing 90.

It is noted that the position of the matching unit 111 is not limited to the above configuration. For example, the matching unit 111 may be disposed on the outer wall-surface 92B of the main wall 92 or on the outer wall-surface 93B of the side wall 93.

### Twelfth Exemplary Embodiment

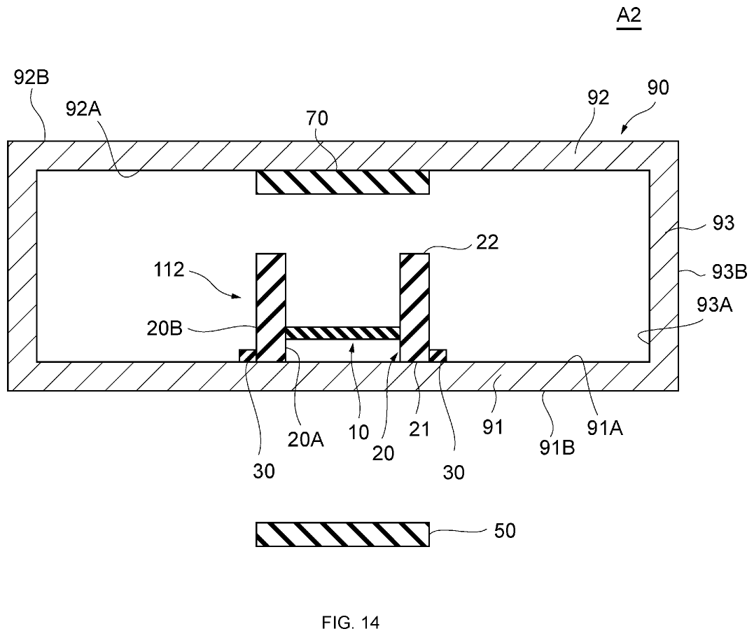

Next, the structure of an acoustic device A2 according to the twelfth exemplary embodiment will be described with reference to FIG. 14. FIG. 14 is a cross-sectional view illustrating the acoustic device of the twelfth embodiment.

The acoustic device A2 further includes a sound collector 70. The sound collector 70 is a microphone that collects the sound emitted by the sound source 50. In the acoustic device A2, a matching unit 112 and the sound collector 70 are disposed in the internal space of the housing 90, whereas the sound source 50 is positioned in the external space of the housing 90. The matching unit 112 is configured to propagate the sound emitted by the sound source 50 efficiently through the housing 90 to the sound collector 70. For example, the sound collector 70 is disposed on the inner wall-surface 92A of the main wall 92, and the matching unit 112 is disposed on the inner wall-surface 91A of the main wall 91. It is also noted that the position of the sound source 50 is not specifically limited. For example, the acoustic device A2 is an unusual-sound detection device, and the sound source 50 is a target device to be inspected.

It is noted that the positions of the matching unit 112 and the sound collector 70 are not limited to the above configuration. For example, the matching unit 112 may be disposed on the inner wall-surface 92A of the main wall 92 or on the inner wall-surface 93A of the side wall 93, whereas the sound collector 70 may be disposed on the inner wall-surface 91A of the main wall 91 or on the inner wall-surface 93A of the side wall 93. The matching unit 112 may also be disposed on the outer wall-surface 91B of the main wall 91, the outer wall-surface 92B of the main wall 92, or the outer wall-surface 93B of the side wall 93.

Yet further, the acoustic device A2 may be equipped with a device, other than the sound collector 70, that obtains and uses the sound of the sound source 50.

### Thirteenth Exemplary Embodiment

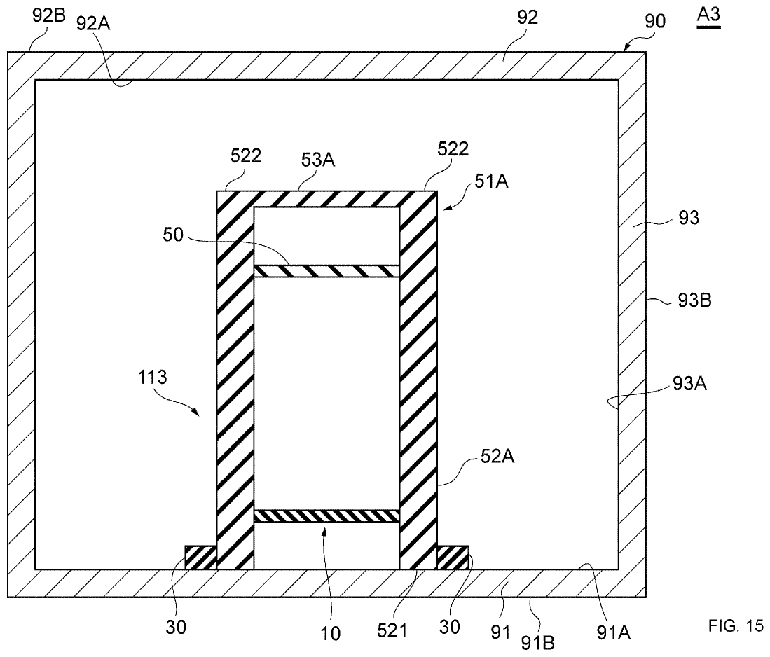

Next, the structure of an acoustic device A3 according to the thirteenth exemplary embodiment will be described with reference to FIG. 15. FIG. 15 is a cross-sectional view illustrating the acoustic device of the thirteenth embodiment.

As being different from the acoustic devices of the other embodiments described above, the acoustic device A3 includes a case 51A, and the sound source 50 is sheltered by the case 51A. In the other embodiments, the support frame is provided to support the vibrating membrane 10 and the sound source 50, whereas in the present embodiment, the case 51A is provided in place of the support frame. The case 51A is disposed on the inner wall-surface 91A of the main wall 91 of the housing 90. The case 51A includes a tubular portion 52A and a capping portion 53A. As illustrated in FIG. 15, the tubular portion 52A of the case 51A supports the vibrating membrane 10 and the sound source 50. In other words, the tubular portion 52A of the case 51A of the sound source 50 serves as a support frame for a matching unit 113. The tubular portion 52A has an end surface 521 being in contact with the main wall 91 of the housing 90 and also has an end surface 522 positioned away from the housing 90. The capping portion 53A of the case 51A is connected to the end surface 522 of the tubular portion 52A and is positioned so as to be spaced from the sound source 50. Yet further, the capping portion 53A can have a vent hole (not illustrated) for alleviating the pressure change in the case 51A caused by the vibration of the sound source 50. Accordingly, the capping portion 53A closes the tubular portion 52A incompletely. The capping portion 53A, however, may close the tubular portion 52A completely. In addition, extension electrodes (not illustrated) are disposed so as to extend from the tubular portion 52A over to the capping portion 53A of the case 51A, thereby enabling electrical connection of the sound source 50 to the outside of the case 51A. The case 51A is fixed to the main wall 91 by the mounting member 30.

### Fourteenth Exemplary Embodiment

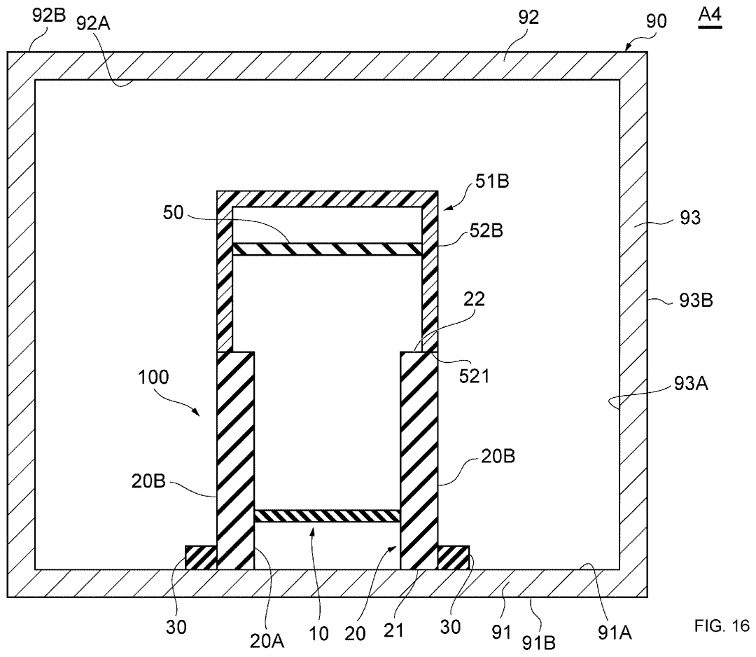

Next, the structure of an acoustic device A4 according to the fourteenth exemplary embodiment will be described with reference to FIG. 16. FIG. 16 is a cross-sectional view illustrating the acoustic device of the fourteenth embodiment.

The fourteenth embodiment is different from the thirteenth embodiment in the structure of the case and the presence of the support frame. In the acoustic device A4 illustrated in FIG. 16, the support frame 20 of the matching unit 100 and a case 51B accommodating the sound source 50 are provided as separate members. The support frame 20 supports the vibrating membrane 10, and the case 51B supports the sound source 50. An end surface 521 of a tubular portion 52B of the case 51B, the end surface 521 being positioned near the main wall 91, is connected to the end surface 22 of the support frame 20, the end surface 22 being positioned away from the main wall 91. The internal space of the tubular portion 52B of the case 51B is in communication with the internal space of the support frame 20.

### Fifteenth Exemplary Embodiment

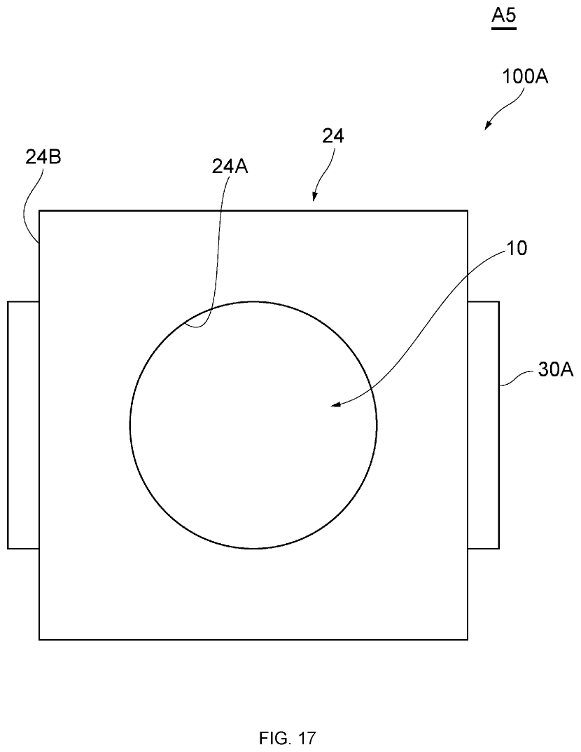

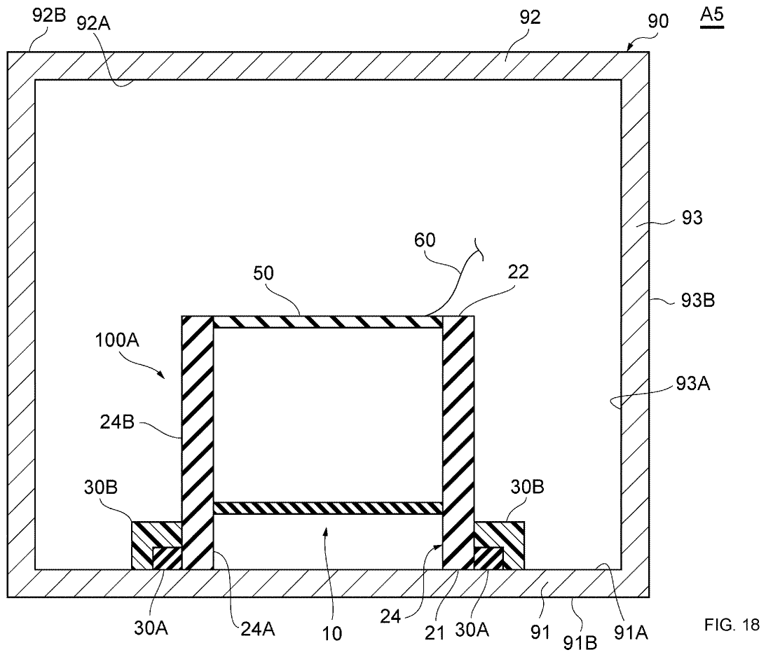

Next, the structure of an acoustic device A5 according to the fifteenth exemplary embodiment will be described with reference to FIGS. 17 and 18. FIG. 17 is a plan view illustrating a matching unit of the fifteenth embodiment. FIG. 18 is a cross-sectional view illustrating the acoustic device of the fifteenth embodiment.

A matching unit 100A of the acoustic device A5 is different from the matching unit of the first embodiment in the shape of the support frame. More specifically, as illustrated in FIG. 17, a support frame 24 of the matching unit 100A has a circular inner surface 24A and a quadrangular outer surface 24B as viewed in plan. In addition, the acoustic device A5 further includes a mounting member 30A and a protrusion 30B for fixing the support frame 24 to the inner wall-surface 91A. As illustrated in FIG. 17, the mounting members 30A are provided on the outer surface 24B so as to interpose the support frame 24 therebetween. As illustrated in FIG. 18, the protrusions 30B are disposed on the inner wall-surface 91A of the housing 90 so as to be able to engage respective mounting members 30A. By engaging the mounting members 30A with the protrusions 30B, the protrusions 30B press the mounting members 30A against the inner wall-surface 91A. When the matching unit 100A is fixed to the housing 90, the mounting members 30A is slid along the inner wall-surface 91A and the protrusions 30B to engage the protrusion 30B. Accordingly, the protrusions 30B are configured as slide rails for fixing the mounting members 30A.

### Sixteenth Exemplary Embodiment

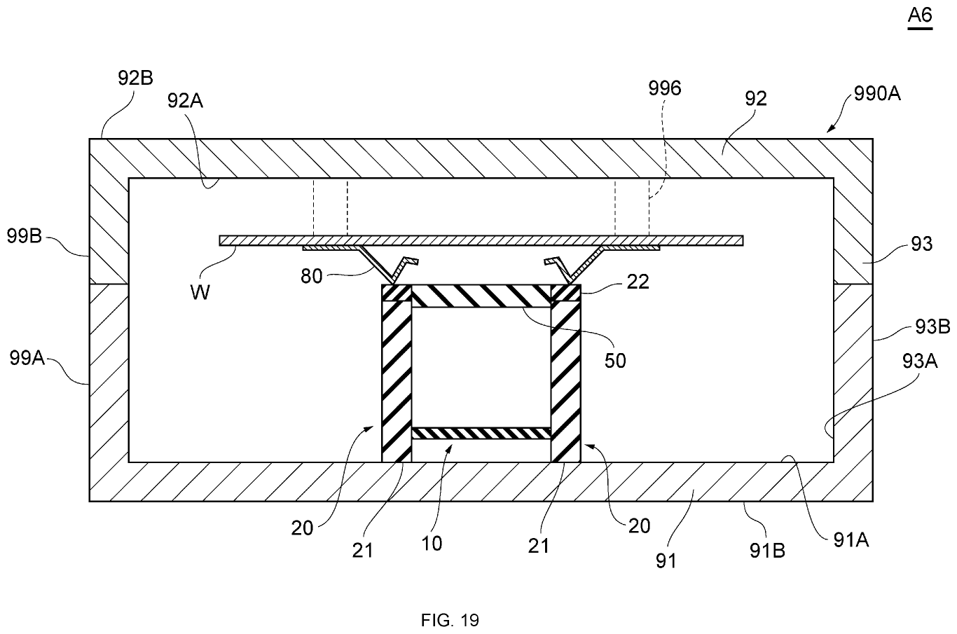

Next, the structure of an acoustic device A6 according to the sixteenth exemplary embodiment will be described with reference to FIG. 19. FIG. 19 is a cross-sectional view illustrating the acoustic device of the sixteenth embodiment.

The acoustic device A6 is different from the acoustic device of the ninth embodiment in the fixation arrangement of the support frame 20. More specifically, in the ninth embodiment, the support frame 20 is fixed using the protrusion 995 of the second portion 99B of the housing 90, whereas in the sixteenth embodiment, the support frame 20 is fixed using fixation members 80 of a substrate W that is connected to the second portion 99B. More in detail, a housing 990A is structured to be separated at a mid-portion of the side wall 93. The housing 990A is made of the first portion 99A that includes the main wall 91 and the second portion 99B that includes the main wall 92. For example, the first portion 99A is engaged with, fitted in, or screw-engaged with the second portion 99B to form the housing 990A. Connection members 996 protrude from the inner wall-surface 92A of the second portion 99B toward the main wall 91, and the substrate W is connected to the end portion of each connection member 996 that faces the main wall 91. The fixation members 80 are disposed on the surface of the substrate W that faces the main wall 91. For example, the fixation members 80 are spring terminals that electrically connect the substrate W to the sound source 50. Note that the fixation members 80 are not limited to the spring terminals but may be pin terminals that electrically connect the substrate W to the sound source 50 or may be insulating spacers that do not contribute to the electrical connection between the substrate W and the sound source 50.

According to this exemplary aspect, the support frame 20 is held tightly by the first portion 99A and the second portion 99B using the substrate W. More specifically, the end surface 21 of the support frame 20 is in contact with the inner wall-surface 91A of the main wall 91, and the end surface 22 of the support frame 20 is in contact with the fixation members 80 of the substrate W. The support frame 20 is urged toward the substrate W by the elastic force of the first portion 99A. The support frame 20 is also urged toward the first portion 99A by the elastic forces of the second portion 99B and the substrate W. The support frame 20 is thereby fixed inside the housing 990A between the main wall 91 and the main wall 92 using the fixation members 80 of the substrate W.

According to the present embodiment, since the substrate W is elastically more deformable than the housing 990A, the support frame 20 is urged more strongly toward the first portion 99A compared with the case of the acoustic device 9 of the ninth embodiment. Accordingly, this configuration improves the fixation strength of the support frame 20 and reduces the occurrence of displacement of the support frame 20. In addition, the spring terminals are used for the fixation members 80, which enables the fixation members 80 to fix the support frame 20 to the housing 990A and simultaneously to connect the substrate W and the sound source 50 electrically. In other words, due to the fixation members being the spring terminals, it is not necessary to provide additional members for electrical connection between the substrate and the sound source. The elasticity of the spring terminals increases the urging force of the support frame 20 toward the first portion 99A and further improves the fixation strength of the support frame 20. It is noted that even if the fixation members are pin terminals or spacers, the fixation members improve the fixation strength of the support frame similarly insofar as the fixation members are elastically deformable. In addition, in the case of the fixation members being the pin terminals, it is not necessary to provide additional members for electrical connection between the substrate and the sound source as is the case for the spring terminals.

As described above, an acoustic device is provided that maximizes the propagation efficiency of sound can while reducing variation therein.

In general, it is noted that the above-described embodiments are provided to facilitate understanding of the present invention and are not intended to limit the present invention. The exemplary aspects of the present disclosure may be modified/improved without departing from the spirit of the present invention, and the present invention includes equivalents thereof. In other words, the embodiments and/or the modification examples may be subjected to design changes by a person skilled in the art, but such modifications fall within the scope of the present invention insofar as the modifications have a characteristic feature of the present invention. For example, the elements and their arrangements, materials, conditions, shapes, sizes, and the like, of the embodiments and/or modification examples are not limited to those described herein by way of example but may be modified as appropriate. In addition, the embodiments and modification examples are illustrative. The configurations described in different embodiments and/or modification examples can be partially replaced or combined with one another, and such replacements and combinations also fall within the scope of the present disclosure insofar as they have the characteristic features of the present disclosure.

### REFERENCE SIGNS LIST

1 acoustic device
100 matching unit
200 sound-producing component
10 vibrating membrane
20 support frame
21, 22 end surface
20A inner surface
20B outer surface
30 mounting member
50 sound source
60 wiring
90 housing
91, 92 main wall
93 side wall
91A, 92A, 93A inner wall-surface
91B, 92B, 93B outer wall-surface

1. An acoustic device comprising:
a matching unit disposed on a wall surface of a housing and configured to match an acoustic impedance for propagating sound from a sound source through the housing,
wherein the matching unit includes:
a support frame having an end surface in contact with the wall surface of the housing,
a vibrating membrane supported by the support frame, and
a mounting member that attaches the support frame to the wall surface of the housing.

2. The acoustic device according to claim 1, further comprising the sound source.

3. The acoustic device according to claim 1, wherein the mounting member is disposed on an outer surface of the support frame.

4. The acoustic device according to claim 1, wherein the mounting member is disposed at two locations or more on the support frame.

5. The acoustic device according to claim 1, wherein the mounting member is disposed along an entire circumference of the support frame.

6. The acoustic device according to claim 1, wherein the mounting member is in contact with the wall surface of the housing that is in contact with the support frame.

7. The acoustic device according to claim 1, wherein the mounting member is spaced from the wall surface of the housing with which the support frame is in contact.

8. The acoustic device according to claim 1, further comprising:
the housing,
wherein a step is provided at the wall surface of the housing at a position between a region of the wall surface that the support frame opposes and a region of the wall surface that the mounting member opposes.

9. The acoustic device according to claim 1, wherein the mounting member is detachably attached to the support frame.

10. The acoustic device according to claim 1, further comprising:
the housing,
wherein the housing includes a first portion and a second portion connected to the first portion, and the support frame is held by the first portion and the second portion.

11. The acoustic device according to claim 1, wherein the matching unit is disposed inside the housing.

12. The acoustic device according to claim 1, wherein the matching unit is disposed outside the housing.

13. The acoustic device according to claim 2, wherein the sound source is disposed inside the housing.

14. The acoustic device according to claim 2, wherein the sound source is disposed outside the housing.

15. The acoustic device according to claim 1, wherein:
the support frame comprises a tubular shape,
a first end of the support frame is a closed end that is closed by the wall surface of the housing, and
the sound source is disposed at a second end of the support frame.

16. The acoustic device according to claim 2, wherein the support frame is disposed at a position spaced from the sound source.

17. An acoustic device comprising:
a housing;
a sound source; and
a matching unit disposed on a wall surface of the housing and configured to match an acoustic impedance for propagating sound from the sound source through the housing,
wherein the matching unit includes:
a support frame having an end surface in contact with the wall surface of the housing,
a vibrating membrane supported by the support frame, and
a mounting member that attaches the support frame to the wall surface of the housing.

18. The acoustic device according to claim 17, wherein a step is provided at the wall surface of the housing at a position between a region of the wall surface that the support frame opposes and a region of the wall surface that the mounting member opposes.

19. The acoustic device according to claim 1 wherein:
the support frame comprises a tubular shape,
a first end of the support frame is a closed end that is closed by the wall surface of the housing, and
the sound source is disposed at a second end of the support frame.

20. The acoustic device according to claim 17, wherein the mounting member is disposed at two locations or more on the support frame.
